(19) United States
(12) Patent Application Publication
(10) Pub. No.: US 2004/0174775 A1
(43) Pub. Date: Sep. 9, 2004

(54) Spiral spring for time measuring device

(75) Inventor: Francesco Muller, Genthod (CH)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Frank Muller Watchland S.A., Genthod (CH)

(21) Appl. No.: 10/383,035

(22) Filed: Mar. 6, 2003

(51) Int. Cl. G04B 17/04

(52) U.S. Cl. 368/177

(57) ABSTRACT

Spiral spring for horology instrument produced all in one piece without molecular discontinuity with its collet.

The object of the invention is a spiral spring for a horology instrument for measuring time.

The spiral springs usually used in horology are made up of several parts, which have to be produced with great accuracy and then assembled to form a composite part. The complexity of the production of such a part generates high costs and complex adjustments.

The purpose of this invention is to propose a spiral spring with as low a production cost as possible and, if possible, without any operating defects.

The spiral spring in accordance with the invention is characterised in that it is made all in one piece without molecular discontinuity with its collet.

A high quality, perfectly balanced part has been produced with the spiral spring in accordance with the invention. The fact that it was produced all in one piece without discontinuity avoids defects inherent in conventional production, and in particular internal stresses in the material and lack of accuracy in the assembly of the constituent parts. Moreover, the cost price of the spiral spring in accordance with the invention is considerably reduced relative to the spring of the prior art.

The production of the spiral spring in accordance with the invention can be carried out advantageously using known techniques, for example through micromoulding operations, by moulding with moulds made by the exposure of UV-sensitive resins, by galvanic deposition processes with or without a mould, by the projection of material or by conventional cutting, particularly by laser, wire EDM or die-sinking EDM, by stamping or by the cutting of sheets of material by high-pressure liquid jet.

The spiral spring may have a stud, also made all in one piece without molecular discontinuity with its terminal curve. The stud may be in the form of a circular cylinder the same height as the leaf of the spiral spring. The stud may be in the form of a part wider than the leaf, offering a certain flexibility allowing it to be inserted by friction into a cavity, and the wider part may be produced in the form of two flexible circular arms. The stud may be inserted by friction into a hole in a support, with the stud being locked by releasing its elastic tension in a hole that is perpendicular to or axially crosses the hole made in the support.

In the spiral spring in accordance with the invention, the collet has a slot and two openings allowing for the part to be statically balanced and gripped with an assembly tool.

The collet may also have reference notches around its edge. The extremitv produced all in one piece with the terminal curve may have one or more notches that mesh with the thread of a screw, the screw being held axially in the support and a bearing bush housed in the support being used as a point of attachment for the spiral.

Finally, the spiral spring may be produced by micromoulding techniques, by moulding with moulds made by the exposure of UV-sensitive resins, by galvanic deposition processes with or without a mould, by the projection of material or by conventional cutting, particularly by laser, wire EDM or die-sinking EDM, by stamping or by the cutting of sheets of material by high-pressure liquid jet.

The drawing shows, as an example, several methods of implementation of the spiral spring in accordance with the invention:

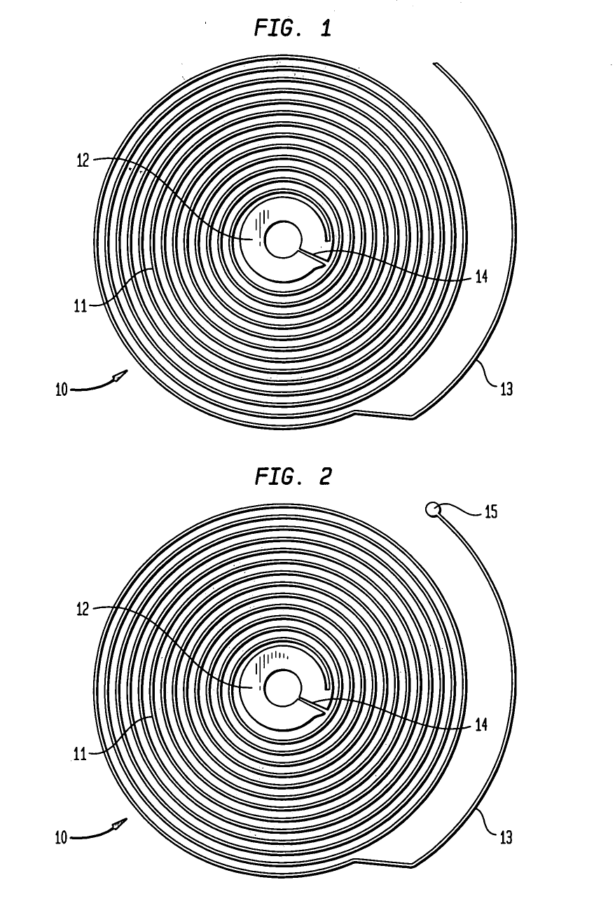

FIG. 1 is a top view of a first method of implementation;

FIG. 2 is also a top view of a variant of the method of implementation in FIG. 1;

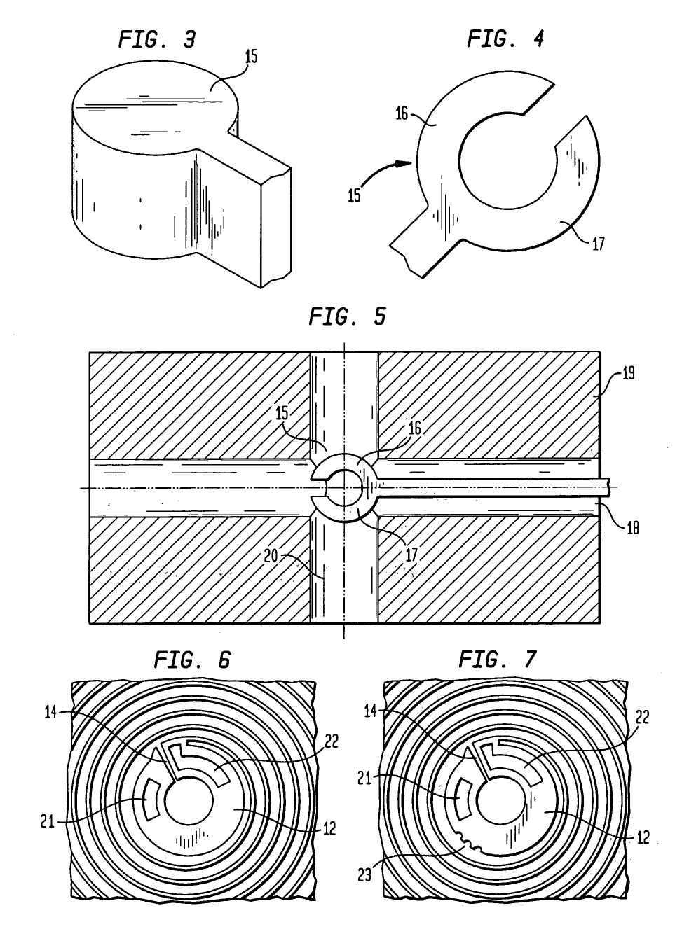

FIG. 3 is a perspective view of a stud placed at the outside extremity of the spiral;

FIG. 4 is a top view of a variant of the stud in FIG. 3;

FIG. 5 is a schematic view of a point of attachment for the stud in FIG. 4, which can be fixed to the conventional stud holder or to the bottom plate of the clock or to the balance bridge;

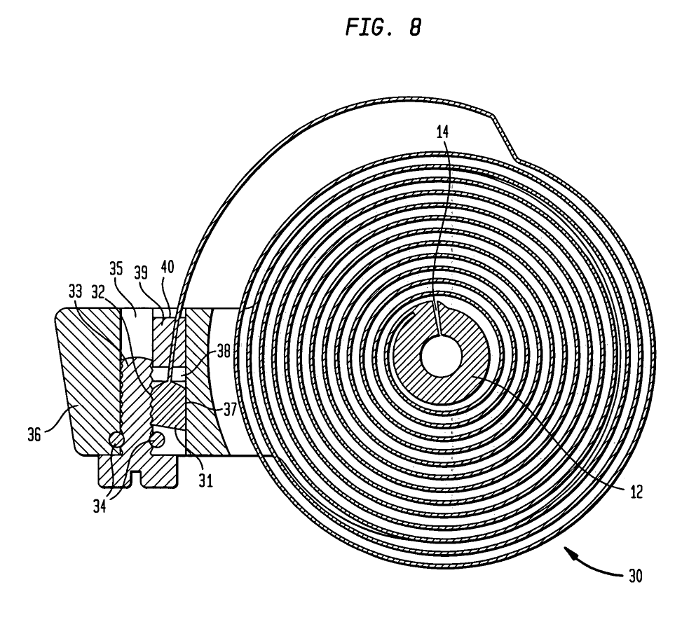

FIG. 6 is a top view of a method of implementation of the collet;

FIG. 7 is a view of a variant of the collet in FIG. 6; and

FIG. 8 is a top view of a second method of implementation of the spiral spring and its adjustment.

The spiral spring shown in FIG. 1 is made up of a leaf 11 with a collet 12 in its centre and a terminal curve 13 at its outside extremity.

The part shown in FIG. 1, with its components 11,12,13 is made all in one piece without discontinuity in its molecular structure.

It can be made using the following techniques:

Micromoulding technique, consisting of depositing a metal inside a mould using a galvanic process.

By the projection of metal onto a base.

By conventional cutting of a sheet of material.

By cutting of a sheet of material by high-pressure liquid jet. The application of the techniques mentioned above were used to produce the spiral spring in FIG. 1 and the variants in FIG. 2 to FIG. 3 with satisfactory results. They were used to obtain the spiral springs in accordance with the invention all in one piece and without molecular discontinuity. The micromoulding production technique in particular gave excellent results.

As shown in FIG. 1, the collet 12 is in the form of a large circular ring and has a slot 14 enabling it to be driven onto a pin without splitting and without buckling on assembly.

The variant shown in FIG. 2 shows the spiral spring 11 with its collet 12 with a slot 14 and its terminal curve 13.

At the extremity of the terminal curve 13 there is a circular stud 15 made all in one piece without molecular discontinuity with the spiral and its collet; obviously, the shape of the stud 15 is not restricted to a circuit configuration and the said stud may be made in any shape desired, for example in a circular shape with a slot as in traditional horology, or in any other suitable geometric shape, and a hole can be made in the centre of the knob on the extremity to facilitate its fixing.

The stud 15 in FIG. 2 is shown in perspective and on a larger scale in FIG. 3.

FIG. 4 shows a variant of the stud 15, which has two circular arms 16 and 17 with a certain flexibility. The stud in FIG. 4 may, given its flexible nature, be inserted by friction into a hole 13 in a movable stud holder 19 or a bottom plate 19 of the horology part. The cart 19 has a perpendicular hole 20 in which the stud 15 in the method of implementation shown in FIG. 4 is locked, after the arms 16 and 17 have returned to their initial positions.

The collet 12 shown in FIG. 6 with its slot 14 has two openings 21 and 22 used firstly to provide static balance to the assembly made up of the leaf 11, the collet and, depending on the case, the terminal curve 13, and secondly to facilitate the manipulation and gripping of the part with a tool.

In the variant shown in FIG. 7, a number of notches are used to distinguish the type of spiral spring. FIG. 7 shows three notches 23; however, the shape and number of the notches can be chosen as needed. The method of implementation shown in FIG. 3 has a spiral ring 30 like the spring in the previous methods of implementation, with its collet 12, the slot 14 and its terminal curve 13.

Here, the stud is in the form of a widened extremity 31 produced without molecular discontinuity with the terminal curve 13. The extremity 31 has notches 32 that mesh with the thread on a screw 33 held by means of two pins 34 inside a hole 35 in a support 36.

The part opposite the teeth 32 of the extremity 31 has a smooth surface 37 allowing the extremity 31 to slide against a surface 38 on the support 36 under the rotating action of the screw 33. The rotation of the screw 33 is therefore used to adjust the position of the extremity 31 in order to vary the active length of the terminal curve 13.

A bearing bush 39 made out of a synthetic material or metal is used to hold the point of attachment 40 of the spiral laterally by friction.

The method of implementation that has just been described and the previous methods of implementation were produced advantageously from a non-magnetic stainless metal alloy using the micromoulding method.

1. Spiral spring for time measuring device characterised in that it is made up of a spiral spring (11) produced in one piece without molecular discontinuity with its collet (12).

2. Spiral spring in accordance with claim 1 characterised in that its stud (15) is also made in one piece without molecular discontinuity with its terminal curve (13).

3. Spiral spring in accordance with claim 2, characterised in that the stud (5) is in the form of a circular cylinder of the same height as the leaf of the spiral spring.

4. Spiral spring in accordance with claim 2, characterized in that the stud (13) is in the form of a part wider than the leaf offering a certain flexibility enabling it to be inserted by friction into a cavity.

5. Spiral spring in accordance with claim 2, characterised in that it has a stud (15) with two flexible circular arms (16,17).

6. Spiral spring in accordance with claim 4, characterised in that it is inserted by friction into a hole (18) in a support (19), the stud being locked by releasing its elastic tension in a hole that is perpendicular to or axially crosses the hole (18) made in the support (19).

7. Spiral spring in accordance with claim 1, characterised in that the collet (12) has a slot (14) and two openings (21 and 22) allowing for the cart to be balanced statically and gripped with an assembly tool.

8. Spiral spring in accordance with claim 7, characterised in that the collet (12) has reference notches (23) around its edge.

9. Spiral spring in accordance with claim 1, characterised in that the extremity (31) made all in one piece with the terminal curve (13) has one or more notches (32) that mesh with the thread of a screw (33), the screw being held axially in the support (36) and a bearing bush (39) housed in the support (38) serving as a point of attachment to the spiral.

10. Spiral spring in accordance with one of the claims 1 to 9, characterised in that it is produced by micromoulding techniques, by moulding with moulds made by the exposure of UV-sensitive resins, by galvanic deposition processes with or without a mould, by the projection of material or by conventional cutting, particularly by laser, wire EDM or die-sinking EDM, by stamping or by the cutting of sheets of material by high pressure liquid jet.
